(19) United States
(12) Patent Application Publication
(10) Pub. No.: US 2023/0081181 A1
(43) Pub. Date: Mar. 16, 2023

(54) APPARATUS FOR PROVIDING A STEERING MOMENT FOR A TWO-WHEELER STEERING MECHANISM

(71) Applicant: Jochen Klieber, Tacherting (DE)

(72) Inventor: Jochen Klieber, Tacherting (DE)

(21) Appl. No.: 17/932,345

(22) Filed: Sep. 15, 2022

(30) Foreign Application Priority Data
Sep. 15, 2021 (DE) 10 2021 123 921.4

(51) Int. Cl. B62K 21/10

(52) U.S. Cl. CPC B62K 21/10

(57) ABSTRACT

An apparatus for providing a steering moment for a two-wheeler steering mechanism has a mounting device for mounting the apparatus on a two-wheeler frame, a coupling device for coupling the apparatus with the two-wheeler steering mechanism and an actuator device for causing a steering force, or a restoring force, that is transmittable to the two-wheeler steering mechanism via the coupling device, The actuator device includes a control interface for controlling the actuator device by a steering control device.

### CROSS-REFERENCE TO RELATED APPLICATIONS

This application claims priority to German application DE 10 2021 123 921.4, filed Sep. 15, 2021, which is hereby incorporated by reference in its entirety.

### FIELD OF THE INVENTION

The present invention relates to an apparatus for providing a steering moment for a two-wheeler steering mechanism. The present invention also relates to a two-wheeler frame, a two-wheeler steering and a two-wheeled vehicle.

### BACKGROUND OF THE INVENTION

The running behaviour of a two-wheeled vehicle may be unstable at low driving speeds. If a running stability is low, the front wheel of the two-wheeled vehicle may tend to tilt to the side. A tilting front wheel and a handlebar that swings to the side as a result may lead to dangerous driving situations.

Also when the front wheel of the two-wheeled vehicle is raised, the front wheel may tilt to the side and the handlebar may swing out to the side. For example, parking or lifting the two-wheeled vehicle or transporting the two-wheeled vehicle may be impaired in this way or result in damage in the environment of the two-wheeled vehicle.

### SUMMARY OF THE INVENTION

In one aspect, the present invention refers to an apparatus for providing a steering moment for a two-wheeler steering mechanism. The steering moment may be a restoring moment. The apparatus may be configured to provide the steering moment in dependency on a steering angle. The steering moment may be a variable steering moment. The two-wheeler steering mechanism may be for example a bicycle steering mechanism or a motorcycle steering mechanism.

The two-wheeler steering mechanism may comprise a fork shaft. The restoring moment may be a restoring moment for restoring a fork shaft or a two-wheeler handlebar that is arranged on the fork shaft, wherein the two-wheeler handlebar may be a bicycle handlebar or a motorcycle handlebar. Therefore, the restoring moment may be a fork shaft restoring moment or a handlebar restoring moment or may cause the fork shaft restoring moment or the handlebar restoring moment. The steering angle may be based on a turning angle of a two-wheeler handlebar of the two-wheeler steering mechanism.

The apparatus may be a two-wheeler component that may be retrofittable to a two-wheeled vehicle or a two-wheeler frame and/or a two-wheeler steering mechanism. Therefore, the apparatus may be mountable on a two-wheeler frame and couplable with the two-wheeler steering mechanism. The two-wheeler component may be a bicycle component and/or a motorcycle component.

The restoring moment may cause a restoring of the two-wheeler steering mechanism to a neutral position of the apparatus. The neutral position may be a state of the apparatus, wherein the state may cause a straight driving of the two-wheeled vehicle. The neutral position may also be a state of the apparatus in which the apparatus may be in a moment equilibrium or in a force equilibrium without an external steering force impact.

The apparatus may comprise a mounting device for mounting the apparatus on a two-wheeler frame. The mounting device may be attachable on the two-wheeler frame. The mounting device may be configured for fixed mounting of the apparatus on the two-wheeler frame.

The apparatus may comprise a coupling device for coupling the apparatus with the two-wheeler steering mechanism. The coupling may be a rotationally fixed coupling. The coupling device may be configured for a rotationally fixed coupling of the apparatus with the fork shaft. The coupling device may be configured for a force-locking and/or a form-locking coupling of the apparatus with the fork shaft. Therefore, the steering angle may correspond to a rotation angle of the fork shaft. The two-wheeler handlebar may be connected with the fork shaft via a handlebar stem in a rotationally fixed manner. Therefore, the steering angle may also correspond to a turning angle of the two-wheeler handlebar.

The apparatus may comprise an actuator device for causing a steering force that is transmittable to the two-wheeler steering mechanism via the coupling device. The transmittable steering force may be a transmittable additional steering force that may superimpose a steering force that is already provided in the steering mechanism. The already provided steering force may be steering force that is manually provided and introduced into the steering mechanism by a two-wheeler driver. If the transmittable steering force is a restoring force, the transmittable steering force may counteract or partly compensate the already provided steering force.

The steering force may be transmittable to the fork shaft. The steering force may be a restoring force. The restoring force may be a restoring force for restoring the fork shaft or the two-wheeler handlebar that is arranged on the fork shaft. The restoring force may therefore be a fork shaft restoring force or a handlebar restoring force or may cause the fork shaft restoring force or the handlebar restoring force. The actuator device may comprise a control interface for controlling the actuator device by a steering control device. The apparatus may comprise the steering control device.

The actuator device may comprise an actuator for generating a mechanical movement or a force that causes the steering force. The actuator may comprise a respective drive. The actuator may be basically any actuator for generating the mechanical movement or the force. According to an embodiment of the apparatus, the actuator may be a mechanical actuator, for example an electromechanical actuator. According to a further embodiment, the actuator may be an electromechanical actuator. According to yet another embodiment, the actuator may be a hydraulic actuator. The actuator may comprise a respective drive element that transforms a control signal of the steering control device into the mechanical movement or the force. The drive element may be a mechanical drive element, for example an electromechanical drive element, an electromechanical drive element and/or a hydraulic drive element. Thus, the actuator device or the actuator may actively impinge on the two-wheeler steering mechanism to cause the steering force and/or to provide the steering moment. The actuator device or the actuator may indirectly or directly act on the two-wheeler steering mechanism to cause the steering force and/or to provide the steering moment.

The actuator may comprise a transmission element for transmitting the generated movement to the coupling device. The transmission element may be a force transmission element for transmitting a force that is generated by the actuator, wherein the force transmission element may transmit the generated force for causing the steering force.

A setting of a steering moment for a two-wheeler steering mechanism may be improved with the apparatus according to the invention in an advantageous manner. An improved driving behaviour of a two-wheeled vehicle may be achieved as an advantageous effect with the invention. The running behaviour of the two-wheeled vehicle may be in particular more stable. Also an improved handling of a bicycle may be further achieved with the invention. A swinging out of a raised front wheel may be in particular avoided. A further particularly advantageous effect of the invention may lie in the fact that an increase scope in laying out the steering geometry parameters of a two-wheeled vehicle is achieved by the improved driving behaviour and the increased running stability of the two-wheeled vehicle. Thus, the steering geometry parameters of a two-wheeled vehicle may be changed over a wider range of parameters by the invention, without thereby jeopardizing the running stability of the two-wheeled vehicle. For example, a wider scope for adjustments or changes to the steering head angle, the front wheel diameter, the bending of the fork or the caster with a front wheel steering may exist with the invention.

According to a further embodiment of the apparatus, the actuator device may be configured to transmit energy to the coupling device in a neutral position of the apparatus, wherein a stabilizing force for stabilizing the two-wheeler steering mechanism can be caused with the energy in the neutral position. The energy that is transmittable to the coupling device may be transmitted to the coupling device by the actuator. The stabilizing force may be a force that acts in the apparatus, for example a tensile force or a compressive force, wherein the transmission element may be in tension or compression in the neutral position. The stabilizing force may counteract a steering of the steering mechanism. Thus, the apparatus may increase the running stability and the handling of the two-wheeled vehicle already in the neutral position.

According to a further embodiment of the apparatus, the actuator device may be configured to transmit energy to the coupling device over a steering angle progression that sets from a neutral position of the apparatus, wherein a variable steering force can be caused with the energy over the steering angle progression that sets from the neutral position of the apparatus. The variable steering force may be caused over the steering angle progression in a continuous manner. The actuator device may be configured to continuously transmit energy to the coupling device over the steering angle progression that sets from the neutral position of the apparatus. Thus, the apparatus may reliably increase the running stability and the handling of a two-wheeled vehicle when a steering angle sets.

According to a further embodiment of the apparatus, the steering control device may comprise a sensor interface for reading in sensorically acquired information on a steering variable, wherein the steering control device may be configured to control the actuator device such that the steering force is caused in dependency on the read in information. The information may be acquired with a steering sensor. The information may also be based on acquisition data of the steering sensor. The information on the steering variable may comprise a steering angle, a steering angle range, a steering angle progression, a steering speed or a steering direction. Therefore, the steering force may be caused in dependency on a steering angle that is currently present in the steering mechanism.

According to a further embodiment of the apparatus, the steering control device may comprise a driving dynamics interface for reading in information on a two-wheeler driving dynamics variable, wherein the steering control device may be configured to control the actuator device such that the steering force is caused in dependency on the read in information. The information may be acquired with a driving dynamics sensor. The information may also be based on acquisition data of the driving dynamics sensor. The information on the two-wheeler driving dynamics variable may comprise a longitudinal dynamics information, for example a driving speed or a two-wheeler longitudinal inclination, or a transverse dynamics information, for example a two-wheeler transverse inclination. Thus, the steering force may be caused in dependency on the current driving dynamics.

According to a further embodiment of the apparatus, the steering control device may be configured to control the actuator device such that a steering force progression, that is transmittable to the two-wheeler steering mechanism via the coupling device, is caused, wherein the steering force progression provides a variable steering moment, in particular a variable restoring moment, when a steering angle progression sets in a predetermined steering angle range. The steering control device may be configured to control the actuator such that the steering force progression is caused by the mechanical movement of the actuator. The steering control device may control the actuator device based on a steering angle that sets. The steering angle may be triggered by a steering force that is provided by two-wheeler driver.

According to a further embodiment of the apparatus, the steering control device may be configured to control the actuator device such that a steering force progression, that is transmittable to the two-wheeler steering mechanism via the coupling device, is caused, wherein the steering force progression provides a progressive development of the steering moment, when a steering angle progression sets from a neutral position of the apparatus in a predetermined steering angle range. The progressive development of the steering moment may merge into a proportional or degressive development of the steering moment in a further steering angle range that adjoins the predetermined steering angle range. The progressive development may improve a direct response behaviour of the apparatus when the steering moment sets from the neutral position in a predetermined steering angle range.

According to a further embodiment of the apparatus, the steering control device may be configured to control the actuator device such that a steering force progression, that is transmittable to the two-wheeler steering mechanism via the coupling device, is caused, wherein the steering force progression provides a degressive development of the steering moment, when a steering angle progression sets in a predetermined steering angle range. According to a further embodiment of the apparatus, a steering angle that sets from the neutral position in the predetermined steering angle range may be smaller in the steering angle progression of the progressive development of the restoring moment compared to a steering angle that sets in the predetermined steering angle range in the steering angle progression of the degressive development of the restoring moment.

According to a further embodiment of the apparatus, the actuator device may comprise two actuator elements for causing the steering force, wherein one of the two actuator elements is configured for causing the steering force at a steering to the right and the other one of the two actuator elements is configured for causing the steering force at a steering to the left. At least one of the actuator elements may be configured such as the described actuator.

According to a further embodiment of the apparatus, the actuator device may be activatable and deactivatable. The actuator device may be manually activated and deactivated via an actuator element by a two-wheeler driver. Alternatively or additionally, the steering control device may be activated and deactivated via the control interface.

The actuator device may be activated and deactivated based on the read in information on the steering variable and/or the read in information on the two-wheeler driving dynamics variable.

According to a further embodiment of the apparatus, the actuator device may be configurable. The actuator device may be self-configurable based on a driving behaviour. Alternatively or additionally, the steering control device may be configured via the control interface. The actuator device may be configured based on the read in information on the steering variable and/or the read in information on the two-wheeler driving dynamics variable. According to a further embodiment of the apparatus, a steering force characteristic diagram that is based on the steering angle may be stored in the steering control device. The steering force characteristic diagram may be a two-wheeler specific and/or a two-wheeler driver specific steering force characteristic diagram. The steering control device may be configured to control the actuator device such that the steering force is caused based on the stored steering force characteristic diagram.

According to a further embodiment of the apparatus, the actuator device may comprise an energy storage device for storing energy for causing the steering force. The energy storage device may be configured for operating the actuator, wherein the energy storage device may supply the actuator with energy for causing the steering force and wherein the energy storage device may therefore be operatively connected in an energetic manner with the actuator. According to a further embodiment of the apparatus, the energy storage device may be operatively connected in an energetic manner with a recuperative two-wheeler system for feeding energy in the energy storage device. Alternatively or additionally, the energy storage device may be operatively connected in an energetic manner with an energy storage, for example an accumulator.

In a further aspect, the present invention refers to a two-wheeler frame, on which the apparatus according to the preceding aspect is mounted. The two-wheeler frame may be a bicycle frame or a motorcycle frame. The apparatus may be mounted on at least one frame tube of the two-wheeler frame, for example on a frame top tube and/or a frame down tube of the two-wheeler frame. According to an embodiment of the two-wheeler frame, the apparatus may be arranged in an integrated manner in at least one frame component of the two-wheeler frame.

In a further aspect, the present invention refers to a two-wheeler steering mechanism, with which the apparatus according to the respective preceding aspect is coupled. The two-wheeler steering mechanism may be a bicycle steering mechanism or a motorcycle steering mechanism.

In a further aspect, the present invention refers to a two-wheeled vehicle that comprises a two-wheeler frame according to the respective preceding aspect or a two-wheeler steering mechanism according to the respective preceding aspect. The two-wheeled vehicle may be a bicycle or a motorcycle.

According to the present invention, embodiments and features of one of the described aspects may establish embodiments and features of a further aspect of the described aspects.

### BRIEF DESCRIPTION OF THE DRAWINGS

FIG. 1 shows in a schematic manner an apparatus for providing a steering moment, a two-wheeler frame and a two-wheeler steering mechanism according to a respective embodiment of the invention; and

FIG. 2 shows in a schematic manner a two-wheeled vehicle with the apparatus from FIG. 1 according to an embodiment of the invention.

### DETAILED DESCRIPTION OF THE INVENTION

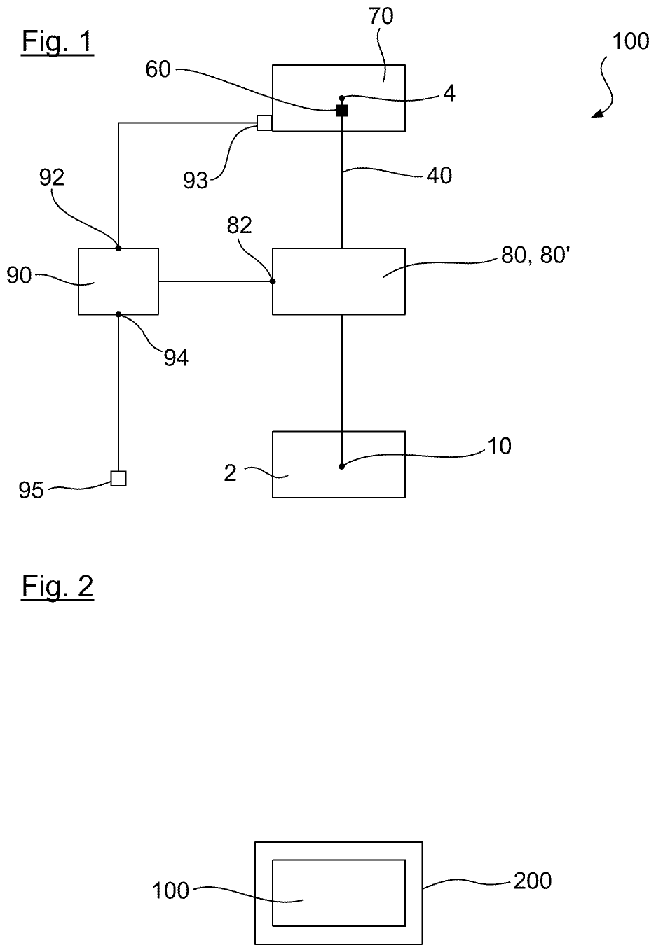

FIG. 1 shows an apparatus 100 that is configured to provide a steering moment for a two-wheeler steering mechanism 70. The apparatus 100 is operatively connected with the two-wheeler steering mechanism 70 via a fork shaft 4 of the two-wheeler steering mechanism 70 such that the apparatus 100 transmits the provided steering moment to the two-wheeler steering mechanism 70. According to an embodiment, the two-wheeler steering mechanism 70 comprises the apparatus 100. The apparatus 100 is mounted on a two-wheeler frame 2 of a two-wheeled vehicle 200, that is shown in FIG. 2, via a mounting device 10. According to respective embodiments, the two-wheeler frame 2 and the two-wheeled vehicle 200 may comprise the apparatus 100.

The apparatus 100 comprises a coupling device 60, with which the apparatus 100 is coupled with the two-wheeler steering mechanism 70. The apparatus 100 is coupled such that a steering force, that is generated by the apparatus 100, may be transmitted to the fork shaft 4 of the two-wheeler steering mechanism 70 to provide the steering moment.

The apparatus 100 further comprises an actuator device 80, with which the steering force may be caused. The actuator device 80 has a control interface 82, via which the actuator device 80 may be controlled by a steering control device 90. The actuator device 80 is connected with the coupling device 60 via a force transmission element 40 to transmit a force, that is generated by at least one actuator element 80′, to the coupling device 60 for causing the steering force.

The steering control device 90 comprises a sensor interface 92, via which acquisition data of a steering sensor 93 may be read in the steering control device 90. The steering control device 90 is configured to control the actuator device 80 based on the read in acquisition data. According to an embodiment, the acquisition data comprises information on a current steering angle of the steering mechanism 70, wherein the steering sensor 93 acquires the steering angle at the steering mechanism 70.

The steering control device 90 may comprise a driving dynamics interface 94, via which acquisition data of a driving dynamics sensor 95 may be read in the steering control device 90. The steering control device 90 is configured to control the actuator device 80 based on the read in acquisition data. According to an embodiment, the acquisition data comprises information on a current driving speed of the two-wheeled vehicle 200, wherein the driving dynamics sensor 95 acquires the speed at a non-shown driving component and/or downthrust component of the two-wheeled vehicle 200.

### REFERENCE SIGNS

2 two-wheeler frame
4 fork shaft
10 mounting device
40 force transmission element
60 coupling device
70 two-wheeler steering mechanism
80 actuator device
80′ actuator element
82 control interface
90 steering control device
92 sensor interface
93 steering sensor
94 driving dynamics interface
95 driving dynamics sensor
100 apparatus
200 two-wheeled vehicle

1. An apparatus for providing a steering moment, or a restoring moment, for a two-wheeler steering mechanism, comprising:
a mounting device for mounting the apparatus on a two-wheeler frame;
a coupling device for coupling the apparatus with the two-wheeler steering mechanism; and
an actuator device for causing a steering force, or a restoring force, that is transmittable to the two-wheeler steering mechanism via the coupling device, wherein the actuator device comprises a control interface for controlling the actuator device by a steering control device.

2. The apparatus according to claim 1, wherein the actuator device is configured to transmit energy to the coupling device in a neutral position of the apparatus, wherein a stabilizing force for stabilizing the two-wheeler steering mechanism is caused with the energy in the neutral position.

3. The apparatus according to claim 1, wherein the actuator device is configured to transmit energy to the coupling device over a steering angle progression that sets from a neutral position of the apparatus, wherein a variable steering force is caused with the energy over the steering angle progression that sets from the neutral position of the apparatus.

4. The apparatus according to claim 1, further comprising the steering control device, wherein the steering control device comprises:
a sensor interface for reading in sensorically acquired information on a steering variable, wherein the steering control device is configured to control the actuator device such that the steering force is caused in dependency on the read in information.

5. The apparatus according to claim 1, further comprising the steering control device, wherein the steering control device comprises:
a driving dynamics interface for reading in information on a two-wheeler driving dynamics variable, wherein the steering control device is configured to control the actuator device such that the steering force is caused in dependency on the read in information.

6. The apparatus according to claim 1, further comprising the steering control device, wherein the steering control device is configured to control the actuator device such that a steering force progression, that is transmittable to the two-wheeler steering mechanism via the coupling device, is caused, wherein the steering force progression provides a variable steering moment, or a variable restoring moment, when a steering angle progression sets in a predetermined steering angle range.

7. The apparatus according to claim 1, further comprising the steering control device, wherein the steering control device is configured to control the actuator device such that a steering force progression, that is transmittable to the two-wheeler steering mechanism via the coupling device, is caused, wherein the steering force progression provides a progressive development of the steering moment, when a steering angle progression sets from a neutral position of the apparatus in a predetermined steering angle range.

8. The apparatus according to claim 1, further comprising the steering control device, wherein the steering control device is configured to control the actuator device such that a steering force progression, that is transmittable to the two-wheeler steering mechanism via the coupling device, is caused, wherein the steering force progression provides a degressive development of the steering moment, when a steering angle progression sets in a predetermined steering angle range.

9. The apparatus according to claim 7, wherein a steering angle that sets from the neutral position in the predetermined steering angle range is smaller in the steering angle progression of the progressive development of the restoring moment compared to a steering angle that sets in the predetermined steering angle range in the steering angle progression of the degressive development of the restoring moment.

10. The apparatus according to claim 1, wherein the actuator device comprises two actuator elements for causing the steering force, wherein one of the two actuator elements is configured for causing the steering force at a steering to the right and the other one of the two actuator elements is configured for causing the steering force at a steering to the left.

11. The apparatus according to claim 1, wherein the actuator device is activatable and deactivatable.

12. The apparatus according to claim 11, wherein by the actuator device is activatable and deactivatable by the steering control device via the control interface.

13. The apparatus according to claim 1, wherein the actuator device is configurable.

14. The apparatus according to claim 13, wherein the actuator device is configurable by the steering control device via the control interface .

15. The apparatus according to claim 1, further comprising the steering control device, wherein a steering force characteristic diagram, that is based on the steering angle, is stored in the steering control device, and wherein the steering control device is configured to control the actuator device such that the steering force is caused based on the stored steering force characteristic diagram.

16. The apparatus according to claim 1, wherein the actuator device comprises an energy storage device for storing of energy for causing the steering force.

17. The apparatus according to claim 16, wherein the energy storage device is operatively connected in an energetic manner with a recuperative two-wheeler system for feeding energy in the energy storage device.

18. A two-wheeler frame, comprising the apparatus of claim 1 mounted on the frame.

19. The two-wheeler frame according to claim 18, wherein the apparatus is arranged in an integrated manner in at least one frame component of the two-wheeler frame.

20. A two-wheeler steering mechanism, comprising the apparatus of claim 1 coupled therewith.

21. A two-wheeled vehicle, comprising:
a two-wheeler frame having;
the two-wheeler frame; and
an apparatus for providing a steering moment, or a restoring moment, for a two-wheeler steering mechanism, comprising:
a mounting device for mounting the apparatus on the two-wheeler frame;
a coupling device for coupling the apparatus with the two-wheeler steering mechanism; and
an actuator device for causing a steering force, or a restoring force, that is transmittable to the two-wheeler steering mechanism via the coupling device, wherein the actuator device comprises a control interface for controlling the actuator device by a steering control device;
or
a two-wheeler steering mechanism having
the two-wheeler steering mechanism; and
an apparatus for providing a steering moment, or a restoring moment, for the two-wheeler steering mechanism, comprising:
a mounting device for mounting the apparatus on a two-wheeler frame;
a coupling device for coupling the apparatus with the two-wheeler steering mechanism; and
an actuator device for causing a steering force, or a restoring force, that is transmittable to the two-wheeler steering mechanism via the coupling device, wherein the actuator device comprises a control interface for controlling the actuator device by a steering control device.
